(19) United States
(12) Patent Application Publication
(10) Pub. No.: US 2008/0154688 A1
(43) Pub. Date: Jun. 26, 2008

(54) GROUPWARE ASSISTANCE TOOL PROVIDING REGULAR APPOINTMENTS OVERVIEW

(75) Inventors: Veronica TOUMANOVA, Karlsruhe (DE); Ramin BAGHERI, Schwetzingen (DE); Sylke SATTLER, Roemerberg (DE); Ingrid REISS, Hirschberg (DE); Daniel BERINGER, New York, NY (US)

Correspondence Address: KENYON & KENYON LLP, 1500 K STREET N.W., SUITE 700, WASHINGTON, DC, 20005, US

(73) Assignee: SAP AG, Walldorf (DE)

(21) Appl. No.: 11/615,201

(22) Filed: Dec. 22, 2006

(51) Int. Cl. G06F 19/00

(52) U.S. Cl. 705/9; 715/772

(57) ABSTRACT

An analytical tool for provides an organized view of user appointment data from a groupware application. The work center organizes the appointment data by categorizations that typically are most significant to the user to whom the account belongs. The work center provides views across selectable time scales. Significantly, the work center need not store or create appointment data of its own. Instead, the data of individual appointments are created, maintained and managed by the groupware application. The work center provides an analytical tool through which operators (either the manager himself or the manager's assistant) may generate organized views into the data maintained by the groupware application.

### BACKGROUND

Modern enterprises often use computerized groupware personal information (“PIM”) management applications, such as Microsoft's Outlook product and Lotus Notes through, which their employees can manage their appointments. Although these applications are useful to set up individual appointments and ensure that appointments do not conflict with each other, current PIM applications often do not provide analytical tools to help operators plan for upcoming appointments.

Some PIM users often participate in a series of regularly recurring appointments of a common type. For example, company executives may be required to attend meetings with a board of directors on a quarterly basis. Sales managers may be required to attend client status meetings a certain number of times per year. Although these meetings do not always occur with a precise frequency of recurrence, each of the recurring appointments may require the employee to perform regular activity to prepare for the appointments.

Some PIM applications permit an operator to categorize appointments according to a predetermined classification scheme and to filter a view of appointment data according to the categorizations. However, those applications provide very limited organizational functions. No known PIM application provides an organizational tool that a permits an operator to browse through appointment data in a form where appointments of multiple category types are presented simultaneously but maintained in discrete organizational groups. No known application provides such displays at multiple timescales or operates according to a hierarchical classification scheme.

### BRIEF DESCRIPTION OF THE DRAWINGS

FIG. 1 is a simplified functional diagram illustrating a system according to an embodiment of the present invention.

FIG. 2 illustrates a home page of a work center application according to an embodiment of the present invention.

FIG. 3-8 illustrate overviews of the work center application according to various embodiments of the present invention.

FIG. 9 illustrates a detailed view of appointment data according to another embodiment of the present invention.

FIG. 10 illustrates a properties editor according to an embodiment of the present invention.

FIG. 11 illustrates an appointment editor according to an embodiment of the present invention.

### DETAILED DESCRIPTION

Embodiments of the present invention provide an analytical tool, called a “work center” herein, that provides an organized view of user appointment data from a groupware application. The work center may organize the appointment data by categorizations that typically are most significant to the user to whom the account belongs. The work center provides views across selectable time scales. Significantly, the work center need not store or create appointment data of its own. Instead, the data of individual appointments are created, maintained and managed by the enterprise's groupware application. The work center provides an analytical tool through which operators (either the manager himself or the manager's assistant) may generate organized views into the data maintained by the groupware application.

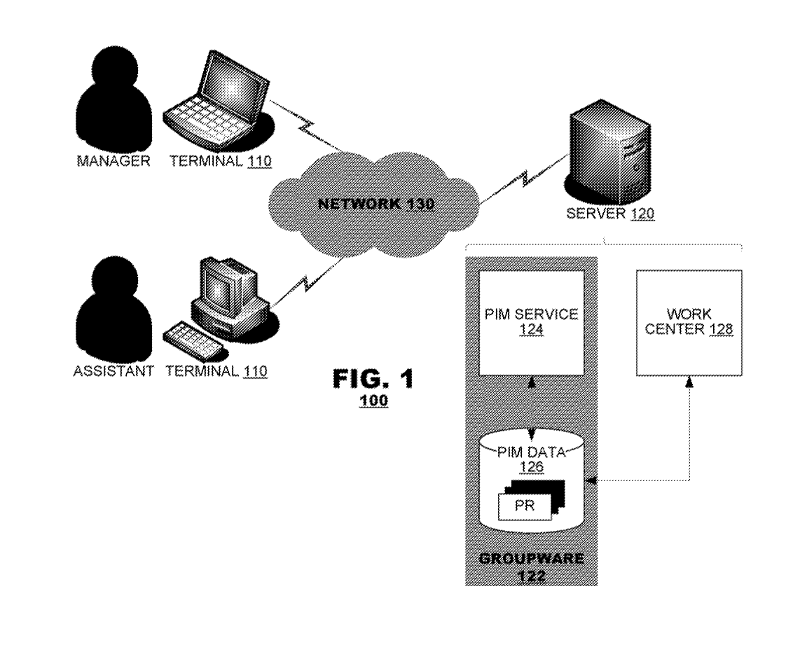

FIG. 1 is a network diagram of a computer system 100 according to an embodiment of the present invention. The system 100 may include one or more terminals 110 and one or more servers 120 provided in mutual communication by a network 130. Operators typically use terminals 110 to access application services, such as groupware applications and the work center, that execute on the servers 120. By way of example, terminals 110 typically include workstations, personal computers and mobile computing devices such as notebook computers, tablet computers, personal digital assistants and even mobile phones. Typically, terminals 110 connect to the network 130 via wireline or wireless connections. For purposes of the present discussion, the number and type of terminal(s) and/or server(s) 110, 120 is immaterial unless otherwise noted. Similarly, the topology of the network 130 and protocols used thereon are immaterial to the present discussion unless otherwise noted.

The server(s) 120 may execute groupware applications, which may provide personal information management (“PIM”) services 124 to manage appointments, contacts, tasks and other data of individual users. In so doing, the groupware application 122 may generate and maintain a PIM database 126 that store appointment data of each user in personal records PR. The server 120 also may execute a work center application 128 as an analytical tool and organizer of the personal records PR. The work center 128 may be provided as a component within the groupware application 122 or, alternatively, as a separate analytical tool.

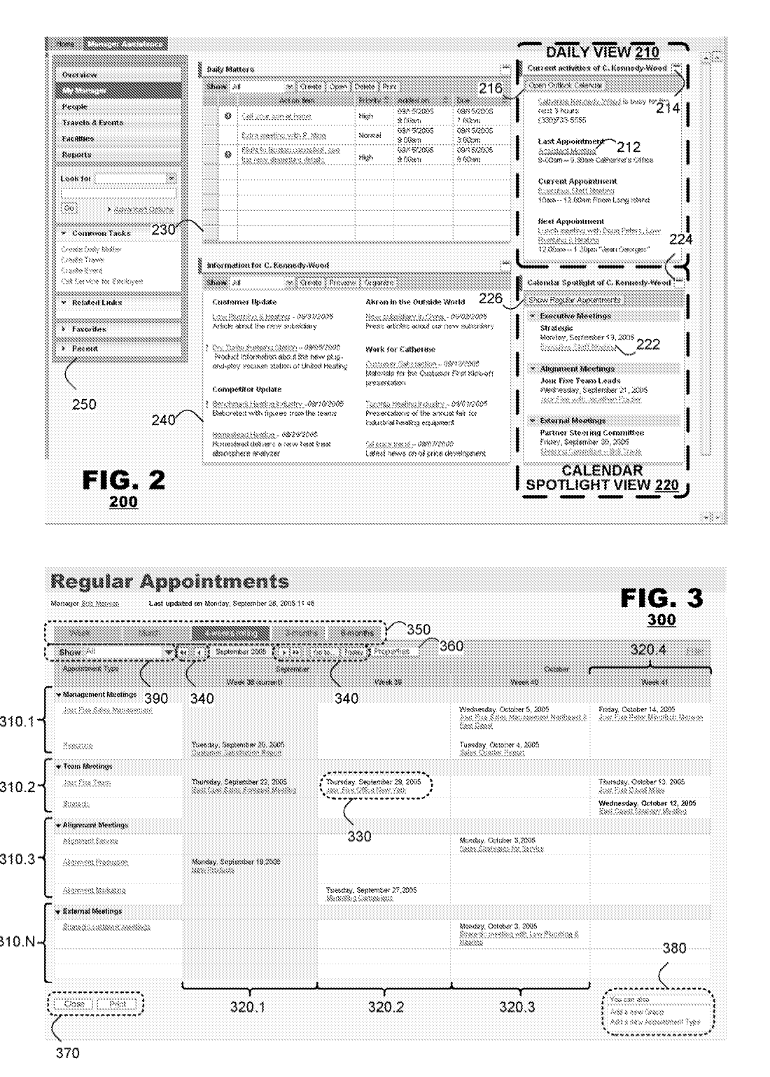

FIG. 2 illustrates an initial view (“home page”) 200 that the work center displays when it is first accessed. The home page 200 includes several panes of content, including a current activities view 210 and a calendar spotlight view 220. For a daily view 210, the work center may present information regarding a predetermined number of current and upcoming appointments—for example, four appointments or appointments within the current day. For the calendar spotlight view 220, the work center application may collect information of upcoming appointments and display them according to the classifications maintained by the work center. In the example of FIG. 2, for example, the work center application presents data of a next appointment in each of the categories maintained. The work center application may access personal records to populate the various panes with content.

In each view 210, 220, the work center may display interactive controls 212, 222, for example, a hyperlink as illustrated or a button (not shown), to permit an operator to open the displayed appointment to edit it. The work center may display other controls 214, 224 to switch individual panes to an overview mode, described in greater detail herein. Further, the work center may display other controls 216, 226, to manage appointment data in greater detail. In the example of FIG. 2, control 216 provides a tool to switch control to the groupware application and manage calendar information therein. Control 226, as illustrated, switches the spotlight view 220 to show regular appoints that are not members of the categories illustrated therein.

The work center home page 200 also may include other controls and content to provide a wider arrange of services. For example, FIG. 2 illustrates a daily matters view 230 listing tasks scheduled to be completed during the current day, a news alert view 240 listing news items or other research materials that are relevant to the manager's occupation, and a navigation pane 250 to navigate to other features of the work center. Thus, the appointments overview may be integrated into an application that provides a wider array of services than discussed in this document.

According to an embodiment of the present invention, the work center provides an organized view of appointment data in a manner that clusters displayed appointments according to predetermined classifications. Typically, operators organize their activities along a series of different types of activity. For example, a manager within an organization may allocate a different amount of time to prepare for meetings with executives or with a board of directors than the manager would allocate to prepare for meetings with subordinates. The manager further might allocate another amount of time to prepare for external meetings in which the manager may meet with his company's clients. In an embodiment, the work center may display appointment data at different time scales in a manner that clusters the appointment data according to classifications that are relevant to the operator's activities.

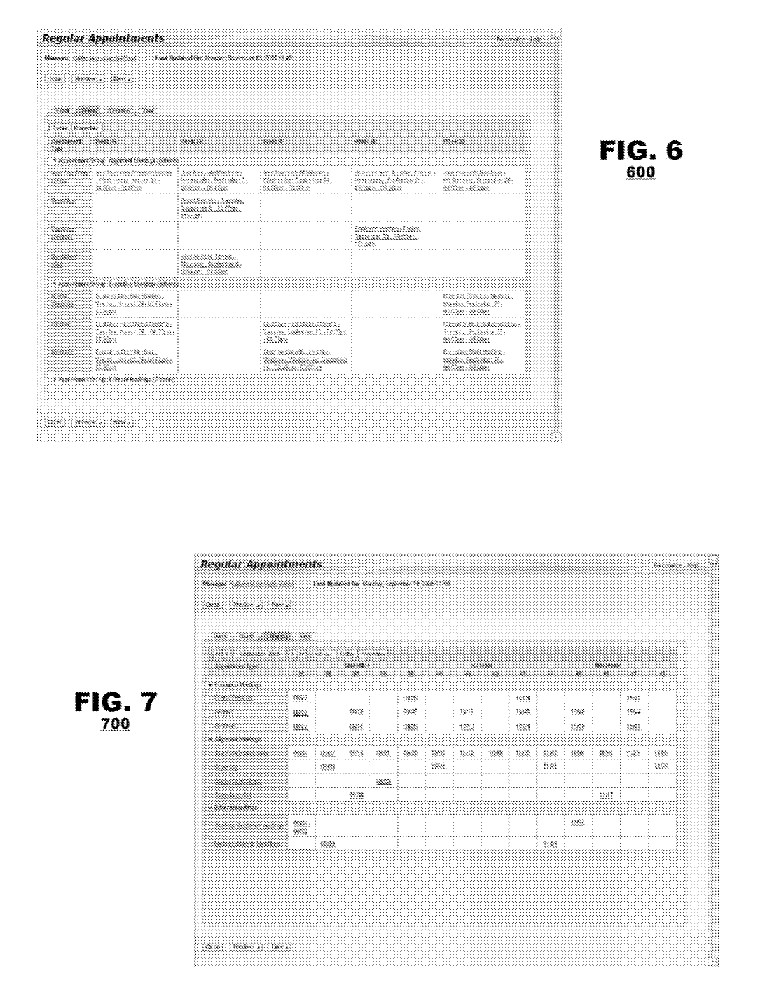

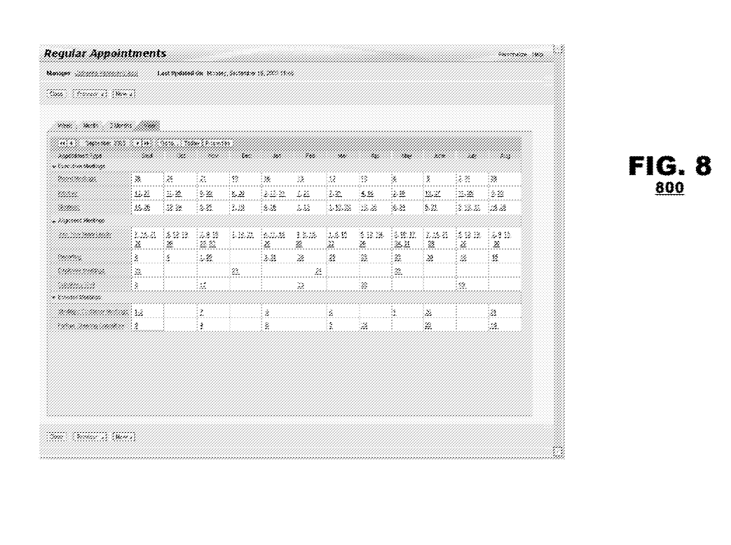

FIGS. 3-8 illustrate various different temporal views that may be supported by the work center using exemplary appointment data and classifications. In these examples, appointment data may be classified according to a multi-level hierarchy as shown in Table 1:

TABLE 1

| APPOINTMENT GROUP | APPOINTMENT TYPE |
|---|---|
| Management Meetings | Jour Fixe Sales Management |
| | Reporting |
| Team Meetings | Jour Fixe Team |
| | Strategic |
| Alignment Meetings | Alignment Service |
| | Alignment Production |
| | Alignment Marketing |
| External Meetings | Strategic Customer Meetings |

In this example, appointments are classified according to a two-level hierarchy in which appointments may be assigned to an appointment “group” and, within a group, to an appointment “type”. In practice, it may often happen that certain appointments (for example, personal appointments), will not be assigned to a classification in the hierarchy. In such as case, the respective appointments may be omitted from the overviews discussed herein.

FIG. 3 illustrates a work center overview 300 taken over a four week view. In this view 300, the work center may displays appointment data in an array that organizes appointment by appointment group and appointment type. When the four week view is active, rows 310.1-310.N of the array containing headings representing appointment groups and appointment types that are active. Columns 320.1-320.4 represent individual time intervals that are relevant to this view; in this case, the columns represent individual weeks. Individual cells (e.g., 330) of the array, which are found at the intersection of the rows and columns, display data representing any appointments fall within the respective time and classification. Cells may display data for as many appointments as are relevant and may be scaled relative to other cells to accommodate the data contained within them. The displayed cell data may include a control (e.g., a hyperlink or button) to navigate to a detailed view of each appointment displayed therein.

The overview 300 may include various controls 340-350 to navigate to different time intervals or time scales as may be desired. Controls 340, for example, permit an operator to navigate incrementally week by week or by an interval equal to the time span being view (e.g., by four week increments as illustrated in FIG. 3), to navigate to a specified date or to navigate to a time span that includes the current date. Controls 350 permit an operator to alter the time scale being view, moving for example from a four week view to a weekly view, a monthly view, a 3 month view or to a six month view.

The overview 300 may include still other controls 360-390 for the work center application. A properties control 360 permits an operator to manages display properties for the overview (e.g., formatting, color codes, etc.). Controls 370 permit an operator to close the work center application or print the currently displayed view. Controls 380 also permit an operator to manage appointment groups and/or appointment types under which appointment data may be classified. A further control 390 permits an operator to select appointment groups and/or types that are to be displayed in a current overview. Thus, an operator is permitted to display all appointment groups/types in a current view or fewer than all to suit the operator's needs.

FIG. 4 illustrates another overview 400 provided by the work center at a three month view. Again, in this view, appointment data may be displayed in an array in which a first axis represents units of time and a second axis represents appointment classifications. In the example of FIG. 4, rows 410.1-410.N group appointments by group and further by appointment type and columns (shown collectively as 420) represent individual weeks within a selected three month range. Individual cells 430, 432 or the array may display information representing appointments that match the respective group/appointment type in the respective time increment.

According to an embodiment, various work center overviews (such as the overview of FIG. 4) may not have an adequate area within the rendered view to display detailed information regarding the respective appointment. In such a case, summary data may be provided, such as a count of the number of appointments that meet the requirements of the respective cell (shown in FIG. 4) or, alternatively, a representation of a date within the time increment on which the appointment is scheduled (e.g., “9/4” to represent September 4^{th}). Additionally, the work center may detect operator interaction with a given cell to display additional information. Certainly, as noted above, a mouse click within a cell can cause the work center to switch control to the groupware application, bringing up a detailed appointment record for direct review. Additionally, however, the work center may respond to user interactivity to display a pop-up window or a tool tip window which contains cursory data relating to the appointment data that meets the requirements of the cell. With respect to cell 432, FIG. 4 illustrates a tool tip window which could be displayed in response to mouse over activity with respect to that cell 432. The tool tip window displays a date and title of the respective appointment.

The work center view 400 of FIG. 4 also may include navigation controls 440, time scale selection controls 450, properties controls 460, application controls 470, classification management controls 480 and view controls 490 as in common with the overview of FIG. 3. Again, the navigation controls 440 may permit an operator to navigate incrementally among different time units, to navigate directly to a selected date or to navigate to a view that includes a current date. Time scale selection controls 450 may switch the current view 400 to a different time scale, such as a weekly, monthly, four week or six month view. A properties control 460 permits an operator to manages display properties for the overview (e.g., formatting, color codes, etc.). Application controls 470, when selected, may close the application or cause a current view to be printed. Classification management controls 480 permit an operator to add, revise or delete appointment group and appointment type definitions. The view control 490 permits an operator to identify which appointment groups and/or types are to be displayed in the overview.

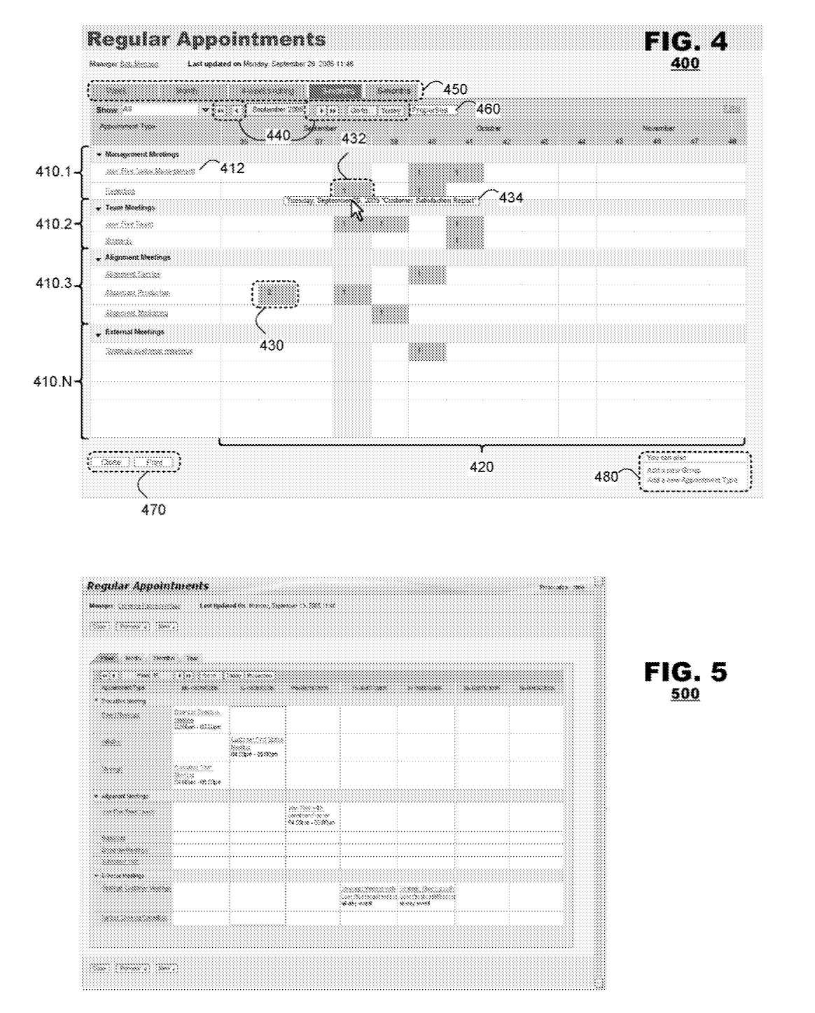

Of course, although the foregoing examples have presented the work center overviews 300, 400 as four week and three month view, the principles of the present invention are not so limited. The work center may be used with other time scale views such as a single week, two weeks, a calendar month, six months and a year (see, for example, FIGS. 5-8). Indeed the work center may accommodate operator-defined timescales. If an operator specifies beginning and ending dates for a desired overview, the work center may present an overview in which a first axis of the array represents the selected timescale and the second axis represents appointment types and/or appointment groups of appointments that fall within the 4 selected date range.

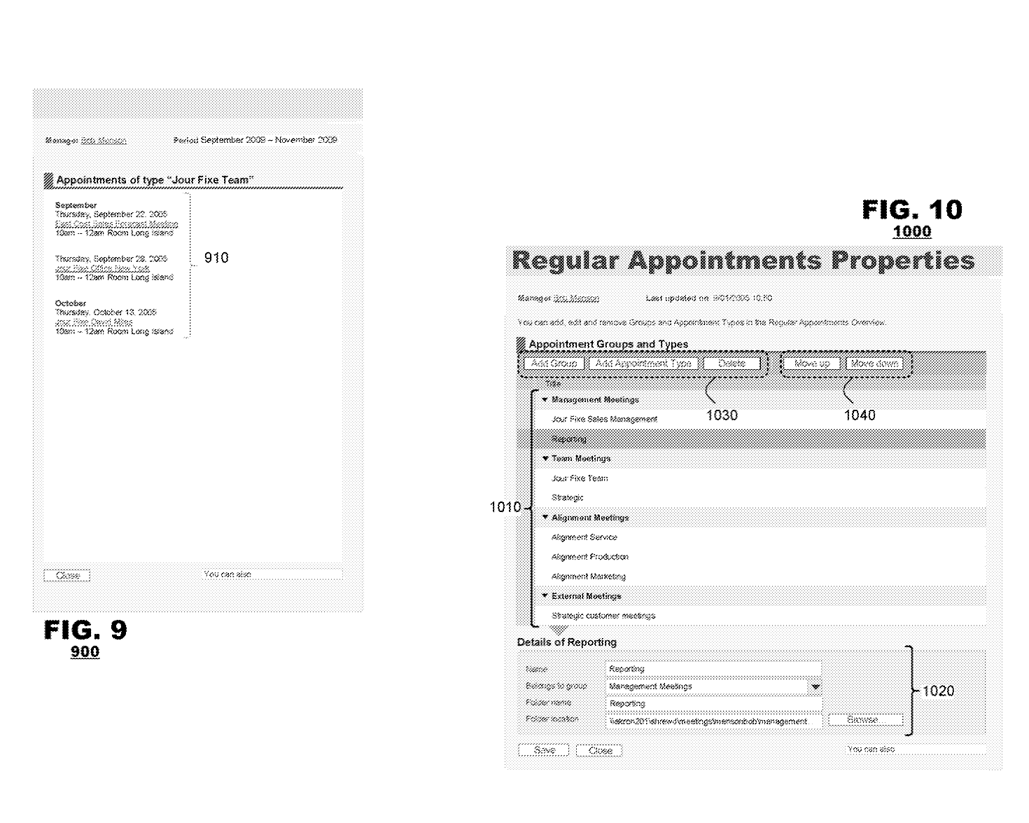

As shown in FIGS. 3-8, individual row headings may include interactive controls that allow an operator to select an appointment group or appointment type (shown as hyperlinks in these examples). FIG. 9 illustrates a detailed view 900 that may be provided by the work center application when an operator engages one such control. In this example, the detailed view 900 corresponds to a three month view, taken from September to November 2005. The work center 900 may present a detailed view of appointment records that match the selected appointment type or appointment group and also fit within the time interval presented in the prior overview view (e.g., view 400 from FIG. 4).

In this detailed view, the presentation need not follow the graphical array presented in the overview view but rather presents the appointment data in an organized list, with a greater amount of detail than could be presented in the prior view. Thus, the example presents data representing the date, title and location of each appointment that fits within the respective type.

FIG. 10 illustrates a properties editor tool 1000 through which an operator may manage groups and appointment types within the work center. The tool 1000 may include a workspace 1010 that presents relationships among appointment group and appointment type classifications as presently organized by the work center. The tool 1000 also may include a control panel 1020 through which an operator may modify settings for a currently selected group or appointment type. For example, an operator may: change the name of a group or appointment type, change assignments of appointment types (change the group to which it belongs), and change folders and folder locations to which documents created under the appointment type are stored.

The properties editor tool 1000 also may include controls 1030 to add new groups, add new appointment types or delete them. Additionally, it may include controls 1040 to move groups and/or appointment types in order of presentation. Using the tool, an operator may add groups or types, delete them or manage relationships among them as needed to satisfy the operator needs. Once appropriate revisions are made, the work center may store a properties record in association with an operator profile and refer to them to organize appointment data for presentation in an overview view.

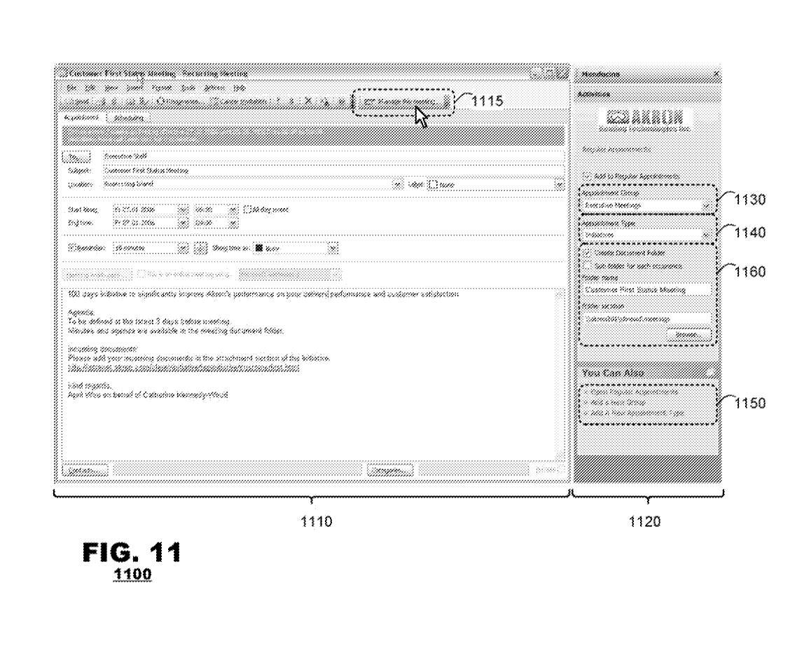

FIG. 11 is a screen shot of an appointment management tool 1100 that may be provided by the work center to organize appointment records. FIG. 11 illustrates an ordinary appointment record 1110 that may be provided by a groupware application (e.g., Outlook, Notes, etc.). The appointment record 1110 may be supplemented by the work center to include a control 1115 that opens a supplementary panel 1120 through which an operator may assign groups and appointment types to the appointment. The panel 1120 may include: a control 1130 to assign the appointment to a group, a control 1140 to assign the appointment to an appointment type within the types that are defined by the group, control(s) 1150 to manage groups and appointment types, and control(s) 1160 to define folders and folder locations where documentation for the appointment type is to be kept.

Several embodiments of the invention are specifically illustrated and/or described herein. However, it will be appreciated that modifications and variations of the invention are covered by the above teachings and within the purview of the appended claims without departing from the spirit and intended scope of the invention.

We claim:

1. A computer system, comprising:
a groupware application to maintain appointment data of a computer user,
a work center application to provide an organized overview of appointment data, the overview displaying appointment data in an array in which:
a first axis of the array representing incremental intervals of time,
a second axis of the array represents appointment classifications, and
cells formed at intersections of the first and second axes present information relating to appointments that coincide with the respective appointment classification and time interval.

2. The computer system of claim 1, wherein the work center stores data representing the appointment classifications in a profile of the computer user.

3. The computer system of claim 1, wherein the work center further comprises a properties editing tool to permit an operator to edit appointment classifications.

4. The computer system of claim 1, wherein the work center overview comprises controls to change a timescale of the overview.

5. The computer system of claim 1, wherein the work center provides a plug in to the groupware application, the plug in providing, when a groupware appointment record editor is active, a tool to assign appointment classifications to the respective appointment record.

6. The computer system of claim 1, wherein the work center overview displays:
appointment classification titles in headings of the second axis and
controls, associated with the classification titles, that when activated causes the work center to display a detailed view of appointment data contained within a currently-displayed timescale of the work center overview and associated with the respective classification.

7. The computer system of claim 1, wherein the appointment classifications are members of a multi-level hierarchy.

8. A computer system, comprising:
a groupware application to maintain appointment data of a plurality of users,
a work center application to provide an organized overview of appointment data for a selected user, the overview displaying appointment data in an array in which:
a first axis of the array representing increments of a timescale,
a second axis of the array represents appointment classifications, and
cells formed at intersections of the first and second axes present information relating to appointments of the selected user that coincide with the respective appointment classification and time increment.

9. The computer system of claim 8, wherein the work center stores data representing the appointment classifications in a profile of the selected user.

10. The computer system of claim 8, wherein the work center further comprises a properties editing tool to permit an operator to edit appointment classifications.

11. The computer system of claim 8, wherein the work center overview comprises controls to change a range of the timescale.

12. The computer system of claim 8, wherein the work center application provides a plug-in to the groupware application, the plug-in providing, when a groupware appointment record editor is active, a tool to assign appointment classifications to the respective appointment record.

13. The computer system of claim 8, wherein the work center overview displays:
appointment classification titles in headings of the second axis and
controls, associated with the classification titles, that when activated causes the work center to display a detailed view of appointment data contained within a currently-displayed timescale of the work center overview and associated with the respective classification.

14. The computer system of claim 8, wherein the appointment classifications are members of a multi-level hierarchy.

15. A work center application, comprising:
an interface to appointment data of an associated groupware application,
a display engine to provide an organized overview of the appointment data, the overview displaying the appointment data in an array that includes:
a first axis of the array representing incremental intervals of time,
a second axis of the array represents appointment classifications, and
cells formed at intersections of the first and second axes present information relating to appointments that coincide with the respective appointment classification and time interval.

16. The application of claim 15, wherein the work center stores data representing the appointment classifications in a profile of the selected user.

17. The application of claim 15, further comprising a properties editing tool to permit an operator to edit appointment classifications.

18. The application of claim 15, wherein the display engine further comprises controls to change a temporal range displayed across the first axis.

19. The application of claim 15, further comprising a plug-in to the groupware application, the plug-in providing, when a groupware appointment record editor is active, a tool to assign appointment classifications to the respective appointment record.

20. The application of claim 15, wherein the display engine displays:
appointment classification titles in headings of the second axis and
controls, associated with the classification titles, that when activated causes the work center to display a detailed view of appointment data contained within a currently-displayed timescale of the work center overview and associated with the respective classification.

21. The application of claim 15, wherein the appointment classifications are members of a multi-level hierarchy.

22. A method, comprising:
responsive to an identified date range, querying a database for appointment data of a computer user that matches the date range,
responsive to query results, dynamically building an overview of responsive appointment data in an array in which:
a first axis of the array representing incremental intervals of time within the date range,
a second axis of the array represents appointment classifications of the appointment data responsive to the query, and
cells formed at intersections of the first and second axes include information relating to appointments that coincide with the respective appointment classification and time interval; and
displaying the overview via a display device.

23. The method of claim 22, wherein the overview comprises controls to change a date range of the overview.

24. The method of claim 22, wherein the overview further includes:
appointment classification titles in headings of the second axis and
controls, associated with the classification titles, that when activated causes the overview to display a detailed view of appointment data contained within the date range of the overview and associated with the respective classification.
